(19) United States
(12) Patent Application Publication
(10) Pub. No.: US 2010/0258695 A1
(43) Pub. Date: Oct. 14, 2010

(54) Hanging Device That Can Bear A Heavier Weight

(76) Inventor: Shih-Piao Wu, Lu Kang Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/423,146

(22) Filed: Apr. 14, 2009

(51) Int. Cl. A47B 96/06; F16B 33/00

(52) U.S. Cl. 248/289.11; 411/378

(57) ABSTRACT

A hanging device includes a fixing member, a mounting member mounted on the fixing member, a positioning member mounted on the mounting member and provided with a serrated engaging portion, a hanging member pivotally mounted on the mounting member and provided with a serrated engaging section detachably engaged with the engaging portion, and an elastic member biased between the mounting member and the positioning member to push the engaging portion toward the engaging section. Thus, the engaging portion of the positioning member engages the engaging section of the hanging member in a planar manner to increase the contact area of the positioning member and the hanging member so that the hanging member is combined with the positioning member tightly and closely and can be used to bear a heavier load.

### BACKGROUND OF THE INVENTION

1. Field of the Invention

The present invention relates to a hanging device and, more particularly, to a hanging device for hanging an article, such as a shower head and like.

2. Description of the Related Art

A conventional hanging device in accordance with the prior art shown in FIGS. 7 and 8 comprises a fixing member 50, and a hanging member 70. The fixing member 50 has a first end provided with a fixing base 51 and a second end provided with a mounting base 53. The fixing base 51 of the fixing member 50 is provided with two fixing holes 52 for fixing the fixing base 51 of the fixing member 50 to an object, such as a vertical wall and the like, by two locking screws (not shown). The mounting base 53 of the fixing member 50 has an inner portion provided with a mounting hole 54 to receive a hollow threaded post 55 and a support tube 56. The hanging member 70 has a first end provided with a rotation seat 71 rotatably mounted on the mounting base 53 of the fixing member 50 and a second end provided with a C-shaped hanging portion 72. The rotation seat 71 of the hanging member 70 has a central portion provided with a shaft hole 74 mounted on the threaded post 55. The rotation seat 71 of the hanging member 70 has an inner portion provided with a chamber 73 which has a bottom wall provided with a plurality of positioning grooves 75. The hanging portion 72 of the hanging member 70 has an inner portion provided with a plurality of clamping ribs 78. A fastening bolt 76 extends through the rotation seat 71 of the hanging member 70 and is screwed into the threaded post 55 to combine the rotation seat 71 of the hanging member 70 and the mounting base 53 of the fixing member 50. An end cap 77 is detachably mounted on the rotation seat 71 of the hanging member 70 to cover the fastening bolt 76. A positioning rod 60 is movably mounted in the support tube 56 and has a first end detachably positioned in one of the positioning grooves 75 of the rotation seat 71. An elastic member 61 is mounted in the support tube 56 and is biased between a second end of the positioning rod 60 and the mounting base 53 of the fixing member 50 to push the positioning rod 60 toward the positioning grooves 75 of the rotation seat 71.

In operation, when a user wishes to adjust the angle of the hanging portion 72 of the hanging member 70, the user can apply a force on the hanging member 70 to overcome the engaging force between the positioning rod 60 and one of the positioning grooves 75 of the rotation seat 71 so that the rotation seat 71 of the hanging member 70 can be rotated relative to the mounting base 53 of the fixing member 50 to adjust the angle of the hanging portion 72 of the hanging member 70. At this time, the positioning rod 60 is pressed by the positioning grooves 75 of the rotation seat 71 to compress the elastic member 61. Thus, after the angle adjustment of the hanging portion 72 of the hanging member 70 is finished, the positioning rod 60 is pushed toward the rotation seat 71 of the hanging member 70 by the restoring force of the elastic member 61 so that the positioning rod 60 is positioned in another one of the positioning grooves 75 of the rotation seat 71.

However, the rotation seat 71 of the hanging member 70 is supported by the engaging force between the positioning rod 60 and one of the positioning grooves 75 of the rotation seat 71 so that the rotation seat 71 of the hanging member 70 is not combined with the mounting base 53 of the fixing member 50 closely. Thus, the hanging member 70 cannot bear a heavier load so that the rotation seat 71 of the hanging member 70 is easily moved relative to the mounting base 53 of the fixing member 50. In addition, the locking screws extend through the fixing holes 52 of the fixing base 51 and are screwed into the vertical wall to attach the fixing base 51 of the fixing member 50 to the vertical wall so that the user needs to operate a hand tool to drive the locking screws, thereby causing inconvenience to the user. Further, the locking screws form two holes in the vertical wall, thereby decreasing the outer appearance of the vertical wall.

### BRIEF SUMMARY OF THE INVENTION

In accordance with the present invention, there is provided a hanging device, comprising a fixing member, a mounting member mounted on a first side of the fixing member, a positioning member mounted on the mounting member and provided with a serrated engaging portion, a hanging member pivotally mounted on the mounting member and provided with a serrated engaging section detachably engaged with the engaging portion of the positioning member, and an elastic member biased between the mounting member and the positioning member to push the engaging portion of the positioning member toward the engaging section of the hanging member.

The primary objective of the present invention is to provide a hanging device that can bear a heavier weight.

Another objective of the present invention is to provide a hanging device, wherein the engaging portion of the positioning member engages the engaging section of the hanging member in an annular planar manner to increase the contact area of the positioning member and the hanging member so that the hanging member is combined with the positioning member tightly and closely and can be used to bear a heavier load.

A further objective of the present invention is to provide a hanging device, wherein a user only needs to drive the drive handle to tighten or loosen the sucker so as to lock or unlock the fixing member so that the hanging device can be mounted on and detached from the object easily and quickly without having to break the structure of the object.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a hanging device in accordance with the preferred embodiment of the present invention.

FIG. 2 is an exploded perspective view of the hanging device as shown in FIG. 1.

FIG. 3 is a front cross-sectional view of the hanging device as shown in FIG. 1.

FIG. 4 is a side cross-sectional view of the hanging device as shown in FIG. 1.

FIG. 5 is a schematic operational view of the hanging device as shown in FIG. 3.

FIG. 6 is a schematic operational view of the hanging device as shown in FIG. 1.

FIG. 7 is an exploded perspective view of a conventional hanging device in accordance with the prior art.

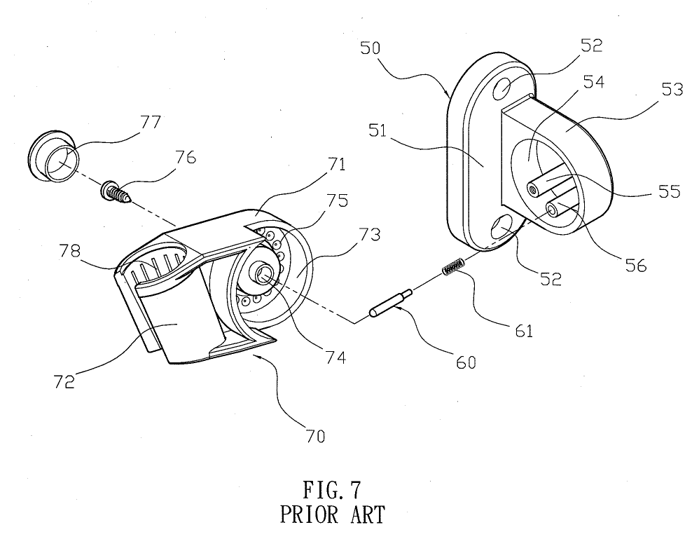

FIG. 8 is a top cross-sectional assembly view of the conventional hanging device as shown in FIG. 7.

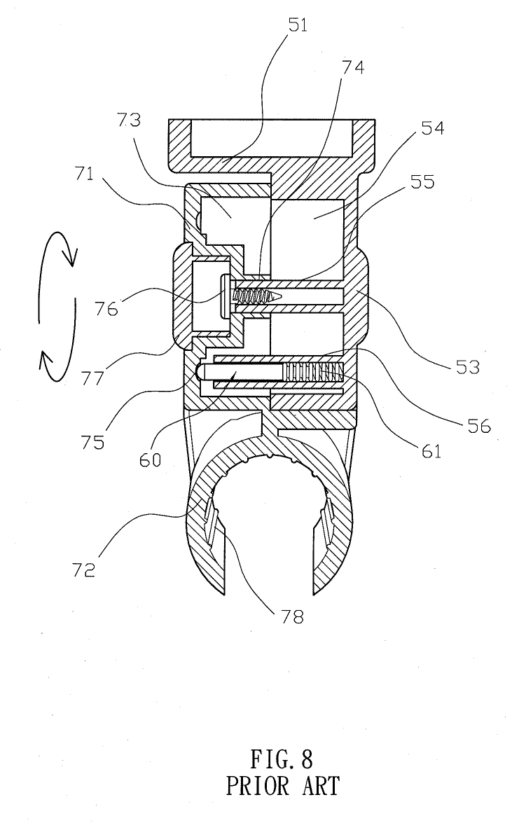

### DETAILED DESCRIPTION OF THE INVENTION

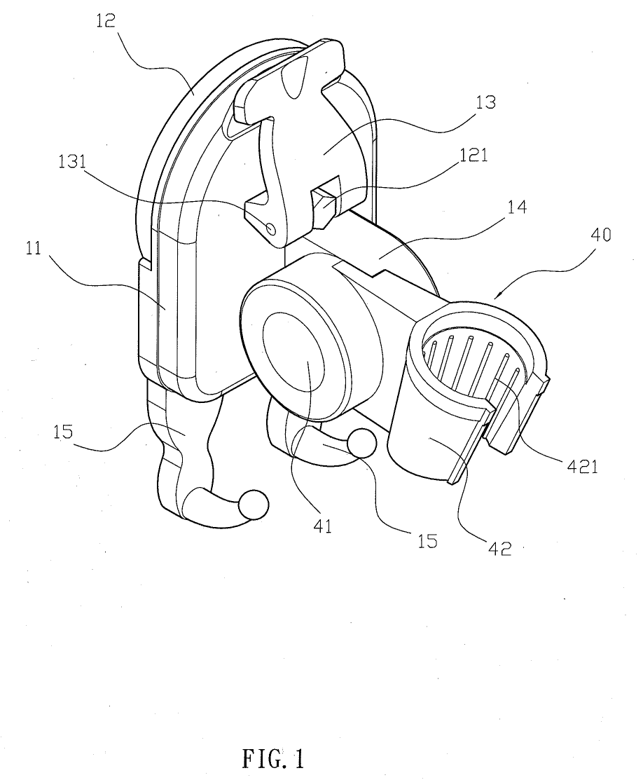

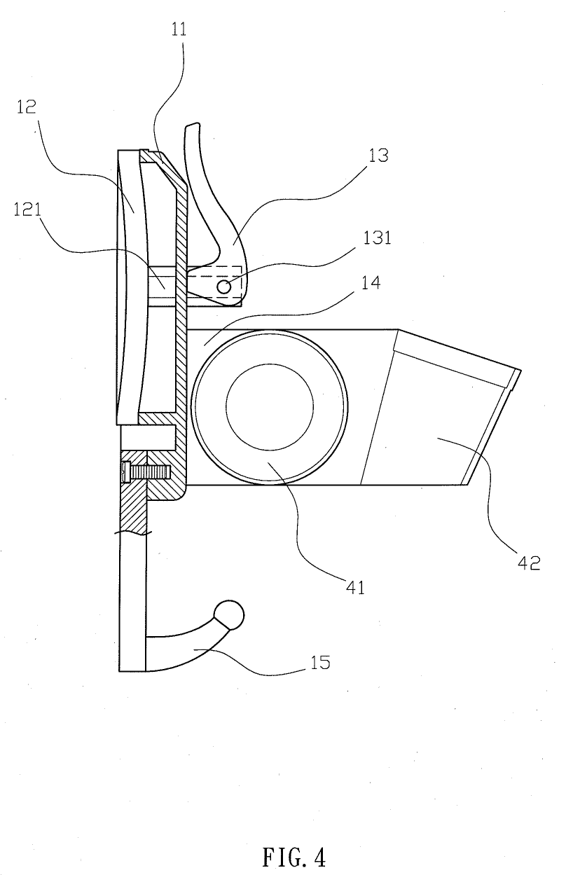

Referring to the drawings and initially to FIGS. 1-4, a hanging device in accordance with the preferred embodiment of the present invention comprises a fixing member 11, a mounting member 14 mounted on a first side of the fixing member 11, a sucker 12 mounted on a second side of the fixing member 11, at least one hook 15 secured on the fixing member 11, a positioning member 30 mounted on the mounting member 14 and provided with a serrated engaging portion 32, a hanging member 40 pivotally mounted on the mounting member 14 and provided with a serrated engaging section 412 detachably engaged with the engaging portion 32 of the positioning member 30, and an elastic member 20 biased between the mounting member 14 and the positioning member 30 to push the engaging portion 32 of the positioning member 30 toward the engaging section 412 of the hanging member 40.

The sucker 12 is provided with a driven stud 121 extending through the fixing member 11 and protruding outwardly from the first side of the fixing member 11, and a drive handle 13 is pivotally mounted on the driven stud 121 of the sucker 12 by a pivot pin 131 and abuts the first side of the fixing member 11. The drive handle 13 is pivoted about the pivot pin 131 eccentrically to compress or release the first side of the fixing member 11 so as to tighten or loosen the sucker 12.

The mounting member 14 has an inner portion provided with a receiving recess 143 to receive the positioning member 30. Preferably, the receiving recess 143 of the mounting member 14 has a substantially circular shape. The inner portion of the mounting member 14 is provided with a limit block 144 mounted in the positioning member 30. The limit block 144 of the mounting member 14 is located in the receiving recess 143 of the mounting member 14 and has a substantially polygonal shape. The limit block 144 of the mounting member 14 has an end face provided with a through hole 145. The limit block 144 of the mounting member 14 has an inner portion provided with a receiving chamber 146 connected to the through hole 145.

The positioning member 30 is movably mounted in the receiving recess 143 of the mounting member 14 and has a substantially circular shape. The positioning member 30 has an inner portion provided with a mounting hole 31 mounted on the limit block 144 of the mounting member 14 and has a peripheral wall provided with a receiving groove 33 to receive the elastic member 20. The mounting hole 31 of the positioning member 30 has a substantially polygonal shape. Thus, the mounting hole 31 of the positioning member 30 is movable on the limit block 144 of the mounting member 14 and is non-rotatable relative to the limit block 144 of the mounting member 14. The receiving groove 33 of the positioning member 30 surrounds the mounting hole 31 of the positioning member 30. The engaging portion 32 of the positioning member 30 surrounds the mounting hole 31 of the positioning member 30. The engaging portion 32 of the positioning member 30 has an annular shape and is arranged in a radiating manner.

The hanging member 40 has a first end provided with a rotation seat 41 rotatably mounted on the mounting member 14 and a second end provided with a substantially C-shaped hanging portion 42. The rotation seat 41 of the hanging member 40 has a central portion provided with a screw bore 411. The hanging portion 42 of the hanging member 40 has an inner portion provided with a plurality of clamping ribs 421. The engaging section 412 of the hanging member 40 is formed on and located in the rotation seat 41 of the hanging member 40 and surrounds the screw bore 411 of the hanging member 40. The engaging section 412 of the hanging member 40 has an annular shape and is arranged in a radiating manner.

The elastic member 20 is partially received in the receiving groove 33 of the positioning member 30 and partially received in the receiving recess 143 of the mounting member 14. The elastic member 20 partially surrounds the limit block 144 of the mounting member 14. The elastic member 20 and the positioning member 30 are clamped between the rotation seat 41 of the hanging member 40 and the mounting member 14.

The hanging device further comprises a fastening bolt 141 extending through the limit block 144 of the mounting member 14 and the rotation seat 41 of the hanging member 40 to attach the hanging member 40 to the mounting member 14, and an end cap 142 detachably mounted on the mounting member 14 to cover the fastening bolt 141. The fastening bolt 141 extends through the through hole 145 of the limit block 144 and is screwed into the screw bore 411 of the rotation seat 41. The end cap 142 is partially inserted into the receiving chamber 146 of the limit block 144.

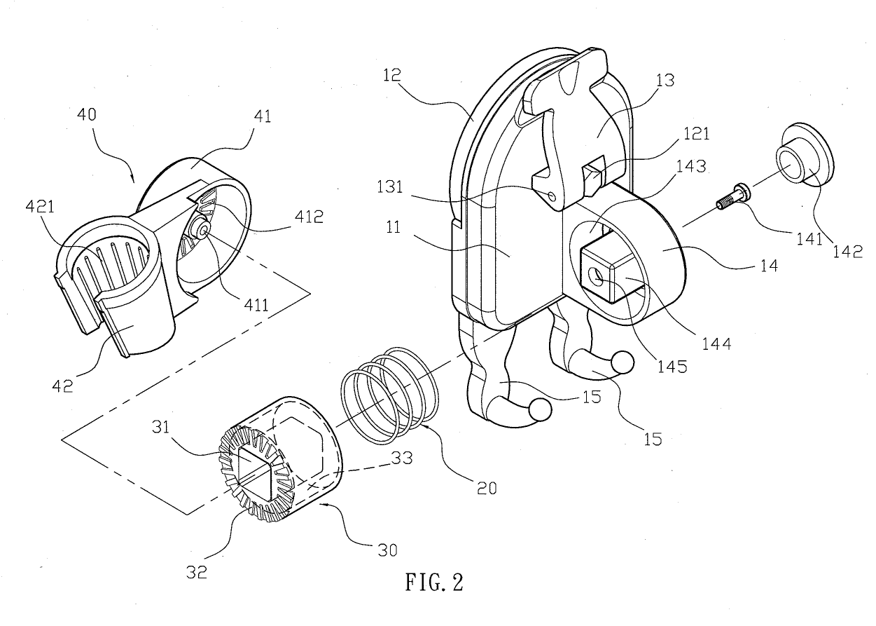

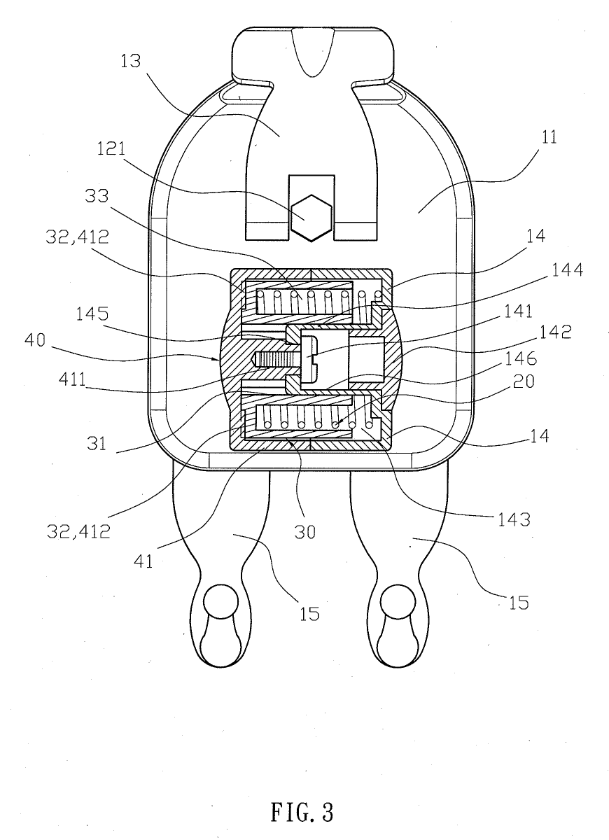

In operation, referring to FIGS. 3-6 with reference to FIGS. 1 and 2, the fixing member 11 is attached to an object, such as a vertical wall and the like, by the sucker 12. In such a manner, a user only needs to drive the drive handle 13 to tighten or loosen the sucker 12 so as to lock or unlock the fixing member 11 so that the hanging device can be mounted on and detached from the object easily and quickly. Thus, when the fixing member 11 is attached to the vertical wall, the hanging portion 42 of the hanging member 40 can be used to hold a shower head.

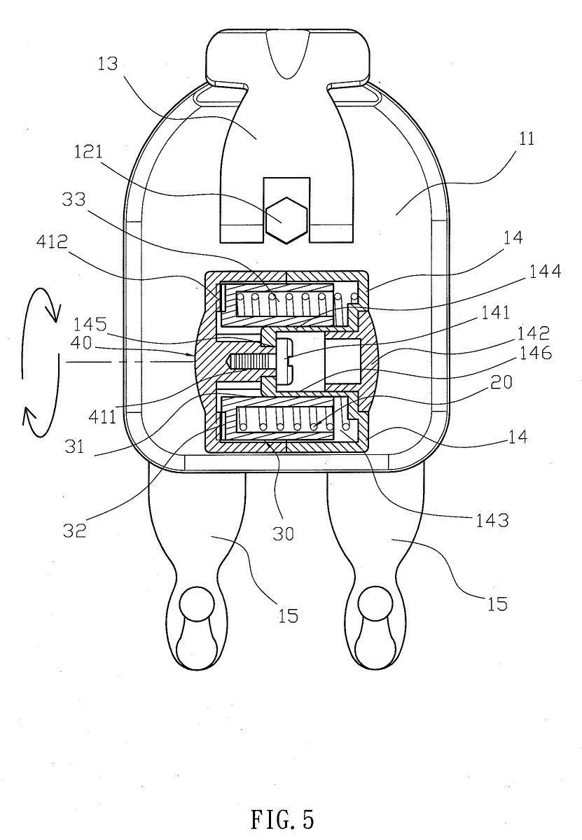

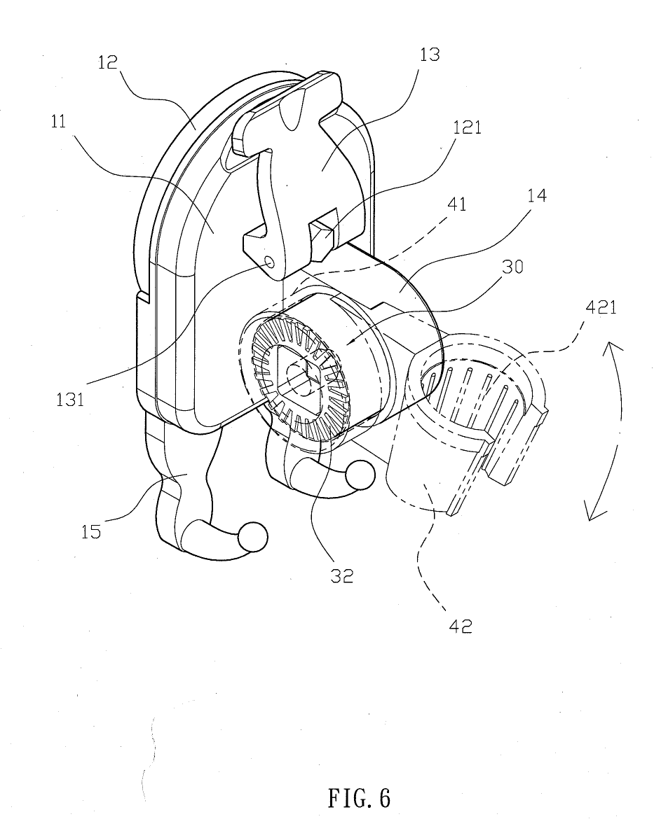

When the user wishes to adjust the angle of the hanging portion 42 of the hanging member 40, the user can apply a force on the hanging member 40 to overcome the engaging force between the engaging section 412 of the hanging member 40 and the engaging portion 32 of the positioning member 30 so that the rotation seat 41 of the hanging member 40 can be rotated relative to the mounting member 14 to adjust the angle of the hanging portion 42 of the hanging member 40 as shown in FIG. 6. At this time, the engaging portion 32 of the positioning member 30 is pressed by the engaging section 412 of the hanging member 40 to drive the positioning member 30 to move toward the elastic member 20 and to compress the elastic member 20 as shown in FIG. 5. Thus, after the angle adjustment of the hanging portion 42 of the hanging member 40 is finished, the positioning member 30 is pushed toward the rotation seat 41 of the hanging member 40 by the restoring force of the elastic member 20 so that the engaging portion 32 of the positioning member 30 engages the engaging section 412 of the hanging member 40 again.

Accordingly, the engaging portion 32 of the positioning member 30 engages the engaging section 412 of the hanging member 40 in an annular planar manner to increase the contact area of the positioning member 30 and the hanging member 40 so that the hanging member 40 is combined with the positioning member 30 tightly and closely and can be used to bear a heavier load. In addition, a user only needs to drive the drive handle 13 to tighten or loosen the sucker 12 so as to lock or unlock the fixing member 11 so that the hanging device can be mounted on and detached from the object easily and quickly without having to break the structure of the object.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hanging device, comprising:
a fixing member;
a mounting member mounted on a first side of the fixing member;
a positioning member mounted on the mounting member and provided with a serrated engaging portion;
a hanging member pivotally mounted on the mounting member and provided with a serrated engaging section detachably engaged with the engaging portion of the positioning member;
an elastic member biased between the mounting member and the positioning member to push the engaging portion of the positioning member toward the engaging section of the hanging member.

2. The hanging device of claim 1, wherein the mounting member has an inner portion provided with a receiving recess to receive the positioning member.

3. The hanging device of claim 2, wherein
the inner portion of the mounting member is provided with a limit block mounted in the positioning member;
the positioning member has an inner portion provided with a mounting hole mounted on the limit block of the mounting member.

4. The hanging device of claim 3, wherein the positioning member has a peripheral wall provided with a receiving groove to receive the elastic member.

5. The hanging device of claim 3, wherein the hanging member has a first end provided with a rotation seat rotatably mounted on the mounting member and a second end provided with a substantially C-shaped hanging portion.

6. The hanging device of claim 5, further comprising:
a fastening bolt extending through the limit block of the mounting member and the rotation seat of the hanging member to attach the hanging member to the mounting member.

7. The hanging device of claim 6, wherein
the limit block of the mounting member has an end face provided with a through hole;
the rotation seat of the hanging member has a central portion provided with a screw bore;
the fastening bolt extends through the through hole of the limit block and is screwed into the screw bore of the rotation seat.

8. The hanging device of claim 1, further comprising:
a sucker mounted on a second side of the fixing member.

9. The hanging device of claim 1, further comprising:
at least one hook secured on the fixing member.

10. The hanging device of claim 1, wherein
the engaging portion of the positioning member has an annular shape and is arranged in a radiating manner;
the engaging section of the hanging member has an annular shape and is arranged in a radiating manner.

11. The hanging device of claim 2, wherein
the receiving recess of the mounting member has a substantially circular shape;
the positioning member is movably mounted in the receiving recess of the mounting member;
the positioning member has a substantially circular shape.

12. The hanging device of claim 3, wherein
the limit block of the mounting member has a substantially polygonal shape;
the limit block of the mounting member is located in the receiving recess of the mounting member;
the mounting hole of the positioning member has a substantially polygonal shape;
the mounting hole of the positioning member is movable on the limit block of the mounting member and is non-rotatable relative to the limit block of the mounting member.

13. The hanging device of claim 7, further comprising:
an end cap detachably mounted on the mounting member to cover the fastening bolt.

14. The hanging device of claim 13, wherein
the limit block of the mounting member has an inner portion provided with a receiving chamber connected to the through hole;
the end cap is partially inserted into the receiving chamber of the limit block.

15. The hanging device of claim 4, wherein
the receiving groove of the positioning member surrounds the mounting hole of the positioning member;
the engaging portion of the positioning member surrounds the mounting hole of the positioning member.

16. The hanging device of claim 7, wherein the engaging section of the hanging member is formed on and located in the rotation seat of the hanging member.

17. The hanging device of claim 16, wherein the engaging section of the hanging member surrounds the screw bore of the hanging member.

18. The hanging device of claim 4, wherein the elastic member is partially received in the receiving groove of the positioning member and partially received in the receiving recess of the mounting member.

19. The hanging device of claim 3, wherein the elastic member partially surrounds the limit block of the mounting member.

20. The hanging device of claim 5, wherein the elastic member and the positioning member are clamped between the rotation seat of the hanging member and the mounting member.
